(19) United States
(12) Patent Application Publication
(10) Pub. No.: US 2006/0246921 A1
(43) Pub. Date: Nov. 2, 2006

(54) A Medical Data Telemetry Management System

(76) Inventor: Tomas Russ, Carlisle, MA (US)

Correspondence Address: Jack Schwartz & Associates;Suite 1510, 1350 Broadway, New York, NY, 10018, US

(21) Appl. No.: 11/380,335

(22) Filed: Apr. 26, 2006

Related U.S. Application Data
(60) Provisional application No. 60/675,258, filed on Apr. 27, 2005.

(51) Int. Cl. H04Q 7/20

(52) U.S. Cl. 455/456.5; 455/450; 455/452.1

(57) ABSTRACT

A medical data telemetry management system for managing acquisition of patient medical data derived from a plurality of patient connected devices includes an acquisition processor for acquiring medical data from a plurality of different patients attached to a corresponding plurality of patient connected devices using a corresponding plurality of communication channels. A communication interface receives a message, including a particular patient connected device identifier, which is generated in response to the detection of proximity of a particular patient connected device to a wireless patient connected device detector. A user interface responds to the detection of proximity of the particular patient connected device to the detector, by initiating generation of a message to a user prompting the user to enter data enabling allocation of a particular communication channel, from among the plurality of communication channels, for use in acquiring medical data from the particular patient on the particular communication channel.

This application derives priority from U.S. Provisional Patent Application Ser. No. 60/675,258, filed on Apr. 27, 2005.

### FIELD OF THE INVENTION

The present invention relates to a medical data telemetry management system, and in particular to a system for managing acquisition of patient medical data acquired by a plurality of patient connected devices.

### BACKGROUND OF THE INVENTION

Clinicians frequently need to remotely monitor physiological parameters on ambulatory patients admitted to the hospital. For example, a patient may be recovering from a heart attack, and a clinician wants the patient to walk around, while monitored, to make sure that there are no underlying cardiac arrhythmias before discharging him. For that purpose a device is attached to the patient that can acquire signals representing, for example, patient electrocardiogram lead signals, which are transmitted by a wireless medium to a remote monitoring station. This is called “ambulatory monitoring”, or “telemetry”, and is a normal technique used in cardiac units and sub-acute care areas of the hospital.

The monitoring technique described above employs at least two devices. First, a patient-connected device (PCD) is used to acquire physiological parameters from a patient and to transmit a wireless signal carrying data representing the acquired physiological parameters. Second, a remote monitoring or presentation device (RMD), is used to receive the wireless signal, and to display an image representing the physiological parameters. The RMD is used by a clinician to monitor the patient physiological signals, and/or to collect, store and analyze the data for later use by the clinician.

An RMD may also acquire data from several PCDs concurrently. One or more PCDs, acquiring respectively different physiological parameters, may be attached to the same patient, and/or respective PCDs may be attached to different patients. Such a multiple-PCD remote monitoring device is called a central station. The respective PCDs include a transmitter for transmitting a wireless patient physiological data representative signal to the RMD. The RMD includes receivers corresponding to the transmitters in the respective PCDs. An RMD typically includes a display device. The image displayed on the display device is partitioned into a plurality of display locations respectively allocated to display data from corresponding PCDs. That is, if six PCDs are associated with an RMD, then the image displayed on the display device is partitioned into six display locations corresponding to the six PCDs, respectively. The image representing medical data acquired by a PCD is displayed in the display location corresponding to that PCD.

FIG. 1 is a block diagram illustrating the overall operation of a medical telemetry management system 10. The system 10 of FIG. 1 includes an RMD 15 with a display device 13 which is capable of handling six PCDs. In, FIG. 1, patient A is connected to PCD A, patient B is connected to PCD B, and patient C is connected to PCD C. The display device 13 is partitioned to include six display locations: DL 1, DL 2, DL 3, DL 4, DL 5 and DL 6, allocated to respective PCDs. In FIG. 1, the display location DL 1 is allocated to PCD A connected to patient A; and the display location DL 6 is allocated to PCD B connected to patient B. In FIG. 1, the display locations DL 1 and DL 6 are displaying respective ECG lead signals.

The link 01 between the PCD A and the display location DL 1 is illustrative and is intended to represent the communication link necessary to carry a signal representing the physiological parameter (ECG lead signal) from the PCD A to the RMD 15 and the signal processing within the RMD 15 necessary to produce a display image representing the physiological parameter in the display location DL 1 on the display device 13. Similarly, the link 02 between the PCD B and the display location DL 6 is intended to represent the communication link necessary to carry the signal containing the physiological parameter (ECG lead signal) from the PCD B to the RMD 15 and the signal processing within the RMD 15 necessary to produce a display image representing the physiological parameter in the display location DL 6 on the display device 130. The communication links include wireless and wired links.

A link between a PCD and the RMD, including the communication link necessary to carry a signal from the PCD to the RMD and the signal processing within the RMD necessary to produce a display image in a particular display location, is termed a communication channel in the remainder of this application. A communication channel may comprise: (a) a communication signal, (b) a particular segment of a communication signal, (c) a particular spatially or temporally distinct signal, and/or (d) a particular spatially or temporally distinct signal portion.

At some point, it is desired to add an additional PCD C, attached to an additional patient C, to the RMD 15. Several parameters are set during the operation of a multiple-PCD remote monitoring system. More specifically, when it is desired to add an additional PCD to the system, a communication channel is allocated between this PCD and a display location on the display device in the RMD. In particular, parameters are set in the RMD and the PCD to allocate a wireless link for signals communicated between the PCD and the RMD. Also, parameters are set in the RMD to allocate a display location on the display device to be associated with the allocated wireless link.

As used herein, a wireless link refers to establishing, maintaining and identifying a wireless communication signal between the RMD and one of the plurality of PCDs. The physiological data may be transmitted via radio waves, optical waves, or any other wireless medium. A parameter of the wireless signal is used to identify the PCD transmitting the signal. For example, a parameter specifying: (a) a carrier frequency in a modulated link, (b) a sequence in a spread spectrum system, (c) a slot or slots in a time division multiplexed system, (d) a source address in a packet-based system, and/or (e) other way of identifying the wireless link, is uniquely allocated to the wireless link to a particular PCD. The RMD identifies the PCD which is the source of a received wireless signal by detecting the parameter (i.e. the carrier frequency, the spread spectrum sequence, and/or the particular slot or slots) in the received wireless signal. The RMD associates data received via the identified wireless link with the transmitting PCD. Once data is identified as coming from a particular PCD the physiological parameters in that data are converted to image form, and displayed in the display location on the display device allocated to that particular PCD. In this manner a communication channel is established between a PCD and a display location on the display device in the RMD.

Early telemetry systems allocate communications channels at the time of manufacture. In such systems, particular PCDs are permanently associated with a particular display location. Referring to FIG. 1, in such a system PCD A is permanently associated with display location DL 1; PCD B is permanently associated with display location DL 6; and PCD C is permanently associated with a particular display location, for example, DL 4. If a PCD becomes inoperative, then the associated communications channel remains inoperative until the PCD is repaired or a replacement PCD fabricated to operate as a part of that communication channel is procured.

Subsequent systems allow communication channels Lo be allocated manually. In such systems, users manually set parameters (e.g. carrier frequency, display location) in PCDs and the associated RMD to set up a communication channel between the PCD and a display location. For example, referring to FIG. 1, a user may manually set parameters in the RMD 15, and PCD C to allocate a wireless link, and associate that wireless link with the display location DL 4. This procedure allows different PCDs to be used in place of an inoperative one, but manual adjustment of the wireless link and association of that link with a display location increases the possibility of errors by the users. This, in turn, leads to a dangerous situation in which physiological parameters from a desired PCD are displayed in an incorrect or unexpected display location leading to erroneous monitoring.

Telemetry systems have been developed in which the RMD includes a contact area for a PCD, and the PCD includes a corresponding contact area. The contact areas are electrical connectors. Wireless link parameters for the PCD are established automatically when the contact area of a PCD is brought into contact with the contact area of the RMD, e.g. when the PCD is physically and electrically connected to the RMD. In a system in which an RMD may be associated with a plurality of PCDs, the RMD includes a plurality of contact areas corresponding to the number of PCDs which may be associated with the RMD. In such systems, the RMD monitors the signals on the available wireless links for activity, and when a PCD is brought into contact with the RMD, an available wireless link is allocated to that PCD. Also in such systems, a particular contact area is permanently associated with a particular display location. That is, contact area 1 is associated with display location DL 1, contact area 2 is associated with display location DL 2, and so forth. Referring to FIG. 1, when PCD C is connected to a particular contact area on the RMD 15, an available wireless link is allocated to PCD C. Concurrently, the wireless link is associated with the display location, for example DL 4, associated with that contact area. A communication link, therefore, is established between PCD C and the display location DL 4. This system permits flexibility in allocating wireless links, but is inflexible in allocating a PCD to a display location.

A system which provides more flexibility in allocating communication channels, specifically in allocating display locations and wireless link parameters, without requiring substantial burdensome clinician manual intervention, is desired. A system according to principles of the present invention addresses this and related problems.

### BRIEF SUMMARY OF THE INVENTION

In accordance with principles of the present invention, a medical data telemetry management system for managing acquisition of patient medical data derived from a plurality of patient connected devices includes an acquisition processor for acquiring medical data from a plurality of different patients attached to a corresponding plurality of patient connected devices using a corresponding plurality of communication channels. A communication interface receives a message, including a particular patient connected device identifier, which is generated in response to the detection of proximity of a particular patient connected device to a wireless patient connected device detector. A user interface responds to the detection of proximity of the particular patient connected device to the detector, by initiating generation of a message to a user prompting the user to enter data enabling allocation of a particular communication channel, from among the plurality of communication channels, for use in acquiring medical data from the particular patient on the particular communication channel.

### BRIEF DESCRIPTION OF THE DRAWING

In the drawing:

FIG. 1 is a block diagram illustrating the overall operation of a medical telemetry management system;

FIG. 2 Is a more detailed block diagram of a medical telemetry management system according to principles of the present invention; and

FIG. 3, FIG. 4, and FIG. 5 are diagrams of display images in a user interface for use in the medical telemetry management system according to principles of the present invention as illustrated in FIG. 2.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or display generator. A display processor or generator is a known element for generating signals representing display images or portions thereof. A processor and a display generator comprises any combination of, hardware, firmware, and/or software.

An executable application, as used herein, comprises code or machine readable instructions for conditioning the processor to implement predetermined functions, such as those of an operating system, medical telemetry management system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display generator under the control of the processor. The UI also includes one or more executable procedures or an executable application. The executable procedures or executable application condition the display generator to generate signals representing the UI display images. These signals are supplied to the display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application, manipulates the UI display images in response to the signals received from the input devices. In this way, the user interacts with the display image using the input devices, enabling user interaction with the processor or other device. A form, as used herein, is a type of UI display image. A form UI display image includes display elements, such as textual display, which prompt the user to enter particular information; and display elements, such as text boxes, check boxes etc., into which the user, using the input devices, may enter the particular information.

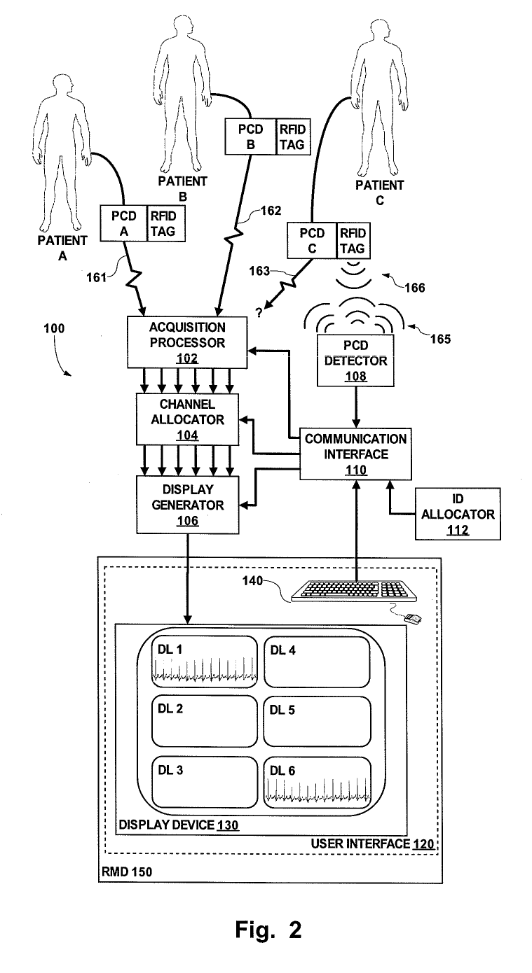

FIG. 2 Is a block diagram of a medical telemetry management system 100 according to principles of the present invention. In FIG. 2, a plurality of patient connected devices (PCDs) are connected to a corresponding plurality of patients: PCD A is connected to patient A, PCD B is connected to patient B, and PCD C is connected to patient C. The respective PCDs have corresponding RFID tags attached to them.

Respective PCDs are coupled to an acquisition processor 102 via corresponding wireless links: wireless link 161 couples PCD A to the acquisition processor 102 and wireless link 162 couples PCD B to the acquisition processor 102. Wireless link 163 is capable of coupling PCD C to the acquisition processor 102 when properly established, as described in more detail below. A plurality of output terminals of the acquisition processor 102 are coupled to corresponding input terminals of a channel allocator 104. A plurality of output terminals of the channel allocator 104 are coupled to corresponding input terminals of the display generator 106. An output terminal of the display generator 106 is coupled to a display device 130 in an RMD 150.

An input device 140 is coupled to a first input terminal of a communication processor 110. The input device 140 is illustrated as a keyboard and mouse. However, one skilled in the art understands that any input device which allows a user to interact with the image displayed on the display device 130, such as switches, push buttons, light pens, touch screens, etc. may be used instead of or in addition to the keyboard and mouse. The combination of the input device 140 and the display device 130 implement a user interface 120.

An output terminal of an identification (ID) allocator 112 is coupled to a second input terminal of the communication processor 110. An output terminal of a PCD detector 108 is coupled to a third input terminal of the communication interface 110. Respective control output terminals of the communication interface 110 are coupled to corresponding control input terminals of the acquisition processor 102, the channel allocator 104, and the display generator 106.

In operation, the medical telemetry management system 100 manages acquisition of patient medical data derived from a plurality of patient connected devices (PCDs). The plurality of PCDs: PCD A, PCD B and PCD C, acquire medical data from the corresponding plurality of different patients, patient A, patient B and patient C, respectively. For example, a PCD may include an ECG monitor which acquires ECG signals from the patient and derives data representing one or more ECG lead signals. Or a PCD may include a pulse oximetry sensor and/or a blood pressure sensor. In addition, a PCD may include sensors for more than one physiological parameter.

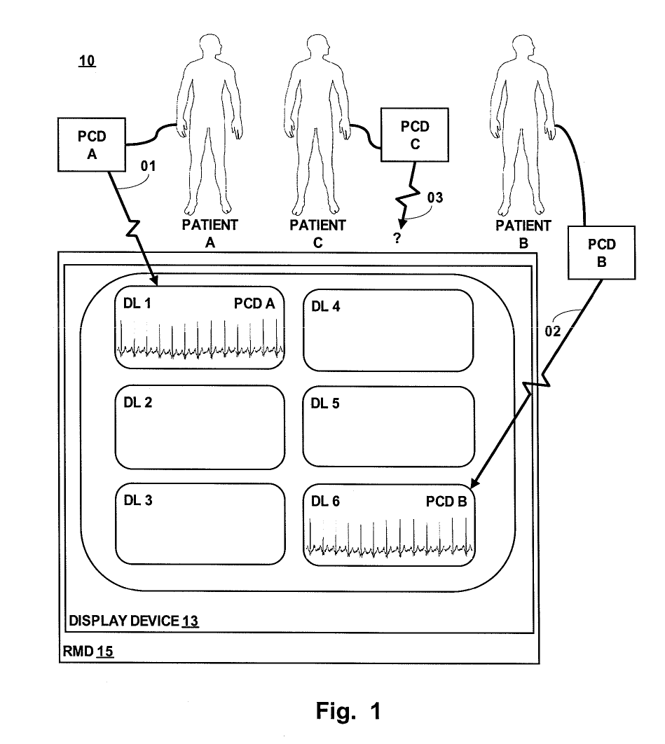

The signals representing the patient medical data acquired by the PCDs are supplied to the acquisition processor 102 via the corresponding wireless links, 161, 162, 163. As described above with respect to FIG. 1, a communication channel is a link between a PCD and the RMD, including the communication link necessary to carry a signal from the PCD to the RMD and the signal processing within the RMD necessary to produce a display image in a particular display location on the display device in the RMD. The wireless links 161, 162, 163 form portions of respective communication channels. The acquisition processor 102 acquires medical data from the plurality of different patients attached to the plurality of patient connected devices using a corresponding plurality of communication channels.

The acquisition processor 102 receives wireless signals from the plurality of PCDs and generates respective signals representing the data carried by the received wireless signals. In the embodiment illustrated in FIG. 2, the RMD 150 is capable of handling six PCDs. One skilled in the art understands that this is exemplary only, and RMDs may be fabricated to handle any number of PCDs. The acquisition processor 102 generates six signals representing medical data received via corresponding wireless links, e.g. 161, 162, from PCDs. In FIG. 2, the first of the six output signals from the acquisition processor 102 corresponds to the wireless link signal 161, the second output signal corresponds to the wireless link signal 162 and so forth.

The channel allocator 104 receives the six signals, representing medical data from the respective wireless links 161, 162, from the acquisition processor 102 and assigns them to respective display locations. The six output signals from the channel allocator 104 are signals representing medical data to be displayed in the six display locations DL 1, DL 2, DL 3, DL 4, DL 5, and DL 6, respectively. The channel allocator 104 routes the input signals representing the data received from the respective wireless links, e.g. 161, 162, to output signals for the respective display locations. In FIG. 2, the first of the six output signals from the channel allocator 104 corresponds to the medical data to be displayed in the display location DL1, the second output signal corresponds to the medical data to be displayed in the display location DL 2, the sixth output signal corresponds to the medical data to be displayed in the display location DL 6, and so forth.

One skilled in the art understands that the illustration of a plurality of signal output terminals for the acquisition processor 102 and channel allocator 104 is illustrative only. The six data signals may be carried on a single signal conductor, may be carried on parallel signal conductors, may be time multiplexed, may be stored in a memory in contiguous or non-contiguous locations and retrieved for subsequent processing from those locations, or passed by similar means from the acquisition processor 102 to the channel allocator 104 and from the channel allocator 104 to subsequent processing circuitry.

The display generator 106 receives the six signals representing the medical data from the PCDs, and generates a signal representing a display image to be displayed on the display device 130, including the medical data acquired from the plurality of patients. This display image includes the six display locations DL 1, DL 2, DL 3, DL 4, DL 5, and DL 6. The display generator 106 generates an image of the medical data represented by the signal at its first input terminal within the first display location DL 1, an image of the medical data represented by the signal at its second input terminal within the second display location DL 2, and so forth. In FIG. 2, the ECG data from PCD A is displayed in the first display location DL 1, and the ECG data from PCD 2 is displayed in the sixth display location DL 6.

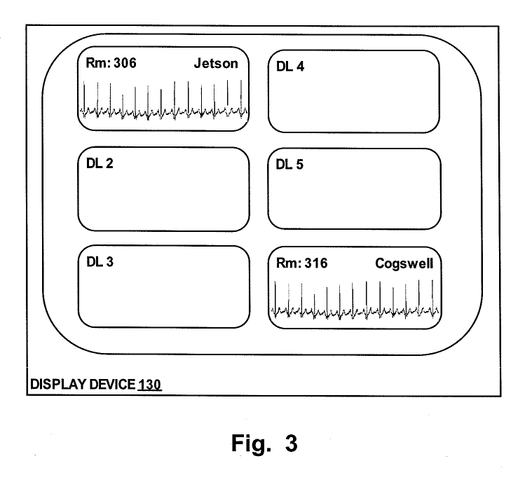

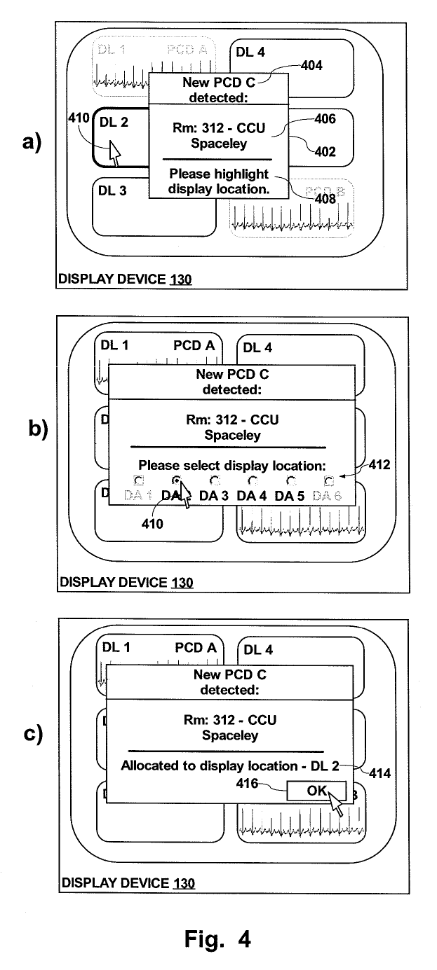

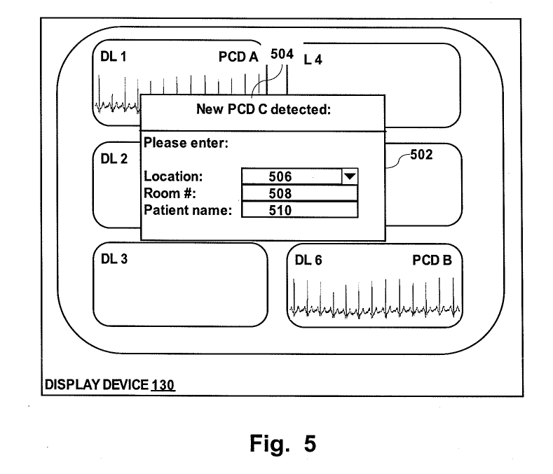

FIG. 3 is a user interface diagram illustrating the display image on the display device 130 generated by the display generator 106 during normal operation of the RMD 150. Referring concurrently to FIG. 2, PCD A, coupled to patient A, and PCD B, coupled to patient B, are transmitting respective wireless signals, 161, 162, carrying data representing respective ECG lead signals. The acquisition processor 102 receives these wireless signals, and the channel allocator 104 routes these signals to desired input terminals of the display generator 106. In particular, in FIG. 3, PCD A is coupled to the upper left display location (e.g. display location DL 1 in FIG. 2) and PCD B is coupled to the lower right display location (e.g. display location DL 6 in FIG. 2. Further patient related information, i.e. patient room number and name, are also displayed in the display locations, in a manner described below.

Referring again to FIG. 2, coupling a PCD to the RMD 150, and establishing a communication channel between them, is described below. The PCD detector 108 wirelessly detects when a PCD is brought in proximity to the RMD 150. One skilled in the art understands that detection of proximity of a particular PCD to the wireless PCD detector 108 may be accomplished by: (a) RFID compatible proximity detection, (b) Bluetooth 802.15 standard compatible proximity detection, (c) GSM/GPRS standard compatible proximity detection, (d) infra-red compatible proximity detection, and/or any other means for detecting proximity of a PCD to the RMD 150. In FIG. 2, use of RFID tags is illustrated.

In general, an RFID tag reader radiates a radio signal. Typically the radio signal is omnidirectional, and relatively low powered. When an RFID tag comes within proximity of the RFID tag reader radio signal, it generates a radio signal in response, which is detected by the RFID tag reader. This signal carries data fabricated into the RFID tag. The data may include a physical identifier of the particular RFID tag which has been activated. In FIG. 2, the PCD detector 108 includes an RFID tag reader, and RFID tags are attached to the respective PCDs. The RFID tag reader in the PCD detector 108 radiates a radio signal 165. The PCD C is brought within proximity of the radio signal 165. The RFID tag on the PCD C generates a radio signal 166 in response. The radio signal 166 includes data representing the PCD identifier of the PCD C.

This signal is detected by the PCD proximity detector 108. The proximity detector 108, in turn generates a message, including the particular PCD identifier, in response to detection of proximity of a particular patient connected device, e.g. PCD C, to the wireless PCD detector 108. This message is supplied to the communication interface 110. The communication interface 110 receives the message, including the particular PCD identifier, generated in response to detection of proximity of the particular PCD, e.g. PCD C, to the wireless PCD detector 108. In response, the communication interface 110 sends a control signal to the acquisition processor 102 to establish a wireless link 163 between the particular PCD, e.g. PCD C, detected to be in proximity to the PCD detector 108 and the acquisition processor 102. The acquisition processor 102 automatically sets parameters (e.g. carrier frequency, sequence, slots, etc.) of the wireless link 163 between PCD C and the acquisition processor 102. The data received from PCD C by the acquisition processor 102 is supplied to the third output terminal of the acquisition processor 102.

Also in response to receipt of the message from the PCD detector 108, the communications interface 110 sends a control signal to the display generator 106. The display generator 106 generates signals representing a user interface (UI) display image and provides that signal to the display device 130 in the user interface 120. Thus, the user interface 120, in response to detection of proximity of the particular PCD, e.g. PCD C, to the PCD detector 108, initiates generation of a message to a user prompting the user to enter data enabling allocation of a particular communication channel, of the plurality of communication channels, for use in acquiring medical data from the particular patient on the particular communication channel. This message comprises a displayed message prompt in the displayed image on the display device 130.

FIG. 4 is a diagram illustrating display images, including message prompts, allowing a user to enter data enabling allocation of a communication channel to the particular PCD, e.g. PCD C. FIG. 4 illustrates display images which may be displayed in different operational modes of the medical data telemetry management system. The particular operational mode of the medical data telemetry management system corresponds to display of a particular menu in an image display.

In a first operational mode, the display image illustrated in FIG. 4a is displayed. In FIG. 4a, a message prompt 402 displays 404 the identifier of the particular PCD, e.g. PCD C, and other data 406 such as: (a) the patient identifier, (b) patient location, (c) a patient room, and/or (d) patient associated label. A message 408 is displayed prompting the user to highlight a display location into which the medical data from the particular PCD, e.g. PCD C, is to be displayed. In FIG. 4a, the two display locations DL 1 and DL 6, which are already allocated to respective active communication channels, are grayed out to indicate that they are not selectable. A cursor 410 may be moved around the screen by the user using the input device 140 (FIG. 2), e.g. using the mouse. When the cursor 410 is atop the desired display location (display location DL 2 in FIG. 4a), the input device 140 may be operated to indicate this, e.g. by activating a button on the mouse. In response, the communication interface 110 sends a control signal to the channel allocator 104 to route the data acquired from the particular PCD, e.g. PCD C, to the selected display location DL 2.

FIG. 4b illustrates an alternative UI display for prompting the user to select a display location for the image of the medical data from the particular PCD, e.g. PCD C. In FIG. 4b, a plurality of radio buttons are displayed corresponding to the available display locations, respectively. In FIG. 4b, the radio buttons for the display locations DL 1 and DL 6 are grayed out to indicate that they are not selectable. The cursor 410 may be moved to be atop the radio button corresponding to the desired display location (display location DL 2), and the mouse button activated. In response, the communication interface 110 (FIG. 2) sends a control signal to the channel allocator 104 to route the data acquired from the particular PCD, e.g. PCD C, to the selected display location DL 2.

In a second operational mode, the display location may be automatically allocated according to predetermined channel allocation rules. In this mode of operation, the channel allocator 104 (FIG. 2) automatically allocates a particular communication channel of the plurality of communication channels to use in acquiring medical data from the particular patient, e.g. patient C, on the particular communication channel using predetermined channel allocation rules in response to detection of proximity of the particular PCD, e.g. PCD C, to the PCD detector 108. The channel allocation rules may be based on: (a) ascending channel number order, and/or (b) a first come first served rule, or any other predetermined rule for assigning new PCDs to an available display location. In FIG. 4c, a newly detected PCD is assigned to the first available display location in ascending order from DL 1 to DL 6. In FIG. 4c, the particular PCD, e.g. PCD C is automatically allocated to display location DL 2. The prompt message 414 includes information for the user indicating in which display location medical data from the particular PCD, e.g. PCD C, is to be displayed. The message prompt may be displayed for a predetermined time period, or may be displayed until a user activates an OK button 416.

When a desired display location has been selected by a user, or automatically allocated, a complete communication channel is allocated linking the particular PCD, e.g. PCD C, to a display location, e.g. display location DL 2. Thus, the channel allocator 104 allocates a particular communication channel for use in acquiring medical data from a particular patient (e.g. patient C), in response to: (a) a particular operational mode of the medical data telemetry management system, and/or (b) data entered by the user in response to the prompting message. Once the communication channel has been allocated, an image of medical data acquired by the PCD C from patient C is displayed in display location DL 2 on the display device 130 in the RMD 150, as described above and illustrated in FIG. 3.

The process described above is repeated when a second PCD is brought into proximity to the PCD detector 108. In such a case, the communication interface 110 receives a message from the PCD detector 108, including data identifying a second PCD identifier of a second PCD attached to a particular patient. The user interface 120 initiates generation of a message to a user prompting the user to enter data enabling allocation of a second particular communication channel to be used in acquiring medical data using the second PCD, or a message to the user that a second particular communication channel has been automatically allocated (see FIG. 4). An image representing the medical data acquired by the second particular PCD is displayed in the user-selected or automatically allocated display location on the display device 130 (see FIG. 3).

It is further desirable to associate acquired medical data received via a wireless link from a PCD with a patient. This data may be entered by the user at the time the particular PCD, e.g. PCD C is detected to be in proximity to the PCD detector 108 (FIG. 2). In this case, the display generator 106 generates a signal carrying data representing a display image of a UI form requesting such information from the user. FIG. 5 illustrates a UI form 502 which may be used to request and receive such information from the user. The user prompt includes text 504 displaying the PCD identifier, e.g. PCD C. The UI form 502 further includes: (a) a text box 506 requesting a patient locator identifier, (b) a text box 508 requesting a patient room, and (c) a text box 510 requesting a patient identifier such as a patient name. Other text boxes requesting other information may also be included, such as a text box (not shown) requesting a patient associated label. The user may use the input device 140 to enter information into the text boxes 506, 508 and 510.

Alternatively, the identifier allocator 112 (FIG. 2) may automatically associate an identifier with medical data acquired from the particular patient in response to detection of proximity of the particular PCD, e.g. PCD C, to the PCD detector 108. The identifier allocator 112 supplies a signal to the communication interface 110 including data representing the identifier. The identifier allocator 112 may associate: (a) a patient identifier, (b) a patient locator identifier, (c) a patient room, and/or (d) a patient associated label, with the particular patient in response to detection of proximity of the particular PCD, e.g. PCD C, to the PCD detector 108. The ID allocator 112 may be coupled to a source (not shown) of such data, such as a hospital database to acquire this information.

The communication interface 110 receives the identifier data entered by the user into the UI form 500 (FIG. 5) from the input device 140, or the identifier data from the identifier allocator 112. In response to receipt of this data, the communication interface 110 sends a message to the acquisition processor 102 including the PCD identifier, e.g. PCD C, of the particular PCD and the identifier data. The acquisition processor 102 associates the acquired medical data received on the particular communication channel allocated to the particular PCD, e.g. PCD C, with the patient identifier, patient name, patient room, patient location, patient associated label and so forth. This information is associated with the medical data received from the particular PCD, e.g. PCD C, and is routed through the channel allocator 104 to the display generator 106. The display generator 106, in turn, initiates generation of data representing a display image including the acquired medical data received on the particular communication channel and: (a) the patient identifier, and/or (b) a name of the particular patient.

Referring again to FIG. 3, the patient room number is illustrated as being displayed in the upper left hand corner and the patient name is illustrated as being displayed in the upper right hand corner of the display locations DL 1 and DL 2, along with the ECG lead signal waveform. The other patient related information may also be displayed in the display location, or may be displayed upon a request from a user.

One skilled in the art recognizes that the plurality of communication channels 161, 162, 163 employ one or more communication links different from the communication link 165, 166 used in detecting proximity of a PCD to the RMD and communicating the message, including the particular patient connected device identifier, to the acquisition processor 102 indicating the detection of proximity of the particular PCD, e.g. PCD C.

What is claimed is:

1. A medical data telemetry management system for managing acquisition of patient medical data derived from a plurality of patient connected devices, comprising:
an acquisition processor for acquiring medical data from a plurality of different patients attached to a plurality of patient connected devices using a corresponding plurality of communication channels;
a communication interface for receiving a message, including a particular patient connected device identifier, generated in response to detection of proximity of a particular patient connected device to a wireless patient connected device detector; and
a user interface for, in response to detection of proximity of said particular patient connected device to said detector, initiating generation of a message to a user prompting said user to enter data enabling allocation of a particular communication channel of said plurality of communication channels for use in acquiring medical data from said particular patient on said particular communication channel.

2. A system according to claim 1 wherein a communication channel comprises at least one of: (a) a communication signal, (b) a particular segment of a communication signal, (c) a particular spatially or temporally distinct signal, and (d) a particular spatially or temporally distinct signal portion.

3. A system according to claim 1 further comprising:
a display generator for initiating generation of data representing a display image including said acquired medical data from said plurality of different patients; wherein
said message to said user comprises a displayed message prompt in a displayed image.

4. A system according to claim 1 wherein said detection of proximity of said particular patient connected device to said wireless patient connected device detector uses at least one of: (a) RFID compatible proximity detection, (b) Bluetooth 802.15 standard compatible proximity detection, (c) GSM/GPRS standard compatible proximity detection, and (d) infra-red compatible proximity detection.

5. A system according to claim 1 further comprising a channel allocator for allocating said particular communication channel for use in acquiring medical data from said particular patient, in response to at least one of: (a) a particular operational mode of said medical data telemetry management system, and (b) data entered by said user in response to said prompting message.

6. A system according to claim 5 wherein said particular operational mode of said medical data telemetry management system corresponds to display of a particular menu in an image display.

7. A system according to claim 1 wherein said corresponding plurality of communication channels employ one or more communication links different from a communication link used in communicating said message including said particular patient connected device identifier.

8. A system according to claim 1 wherein:
said communication interface receives a message including a patient identifier identifying a patient attached to said particular patient connected device; and
said acquisition processor associates acquired medical data received on said particular communication channel with said patient identifier.

9. A system according to claim 8 further comprising a display generator for initiating generation of data representing a display image including said acquired medical data received on said particular communication channel associated with at least one of: (a) said patient identifier, and (b) a name of said particular patient.

10. A system according to claim 1 wherein said user interface initiates generation of a message to a user prompting said user to enter data enabling association of at least one of: (a) a patient identifier, (b) a patient locator identifier, (c) a patient room, and (d) a patient associated label, with said particular patient in response to detection of proximity of said particular patient connected device to said detector.

11. A medical data telemetry management system for managing acquisition of patient medical data derived from a plurality of patient connected devices, comprising:
an acquisition processor for acquiring medical data from a plurality of different patients attached to a plurality of patient connected devices using a corresponding plurality of communication channels;
a communication Interface for receiving a message Including a particular patient connected device identifier generated in response to detection of proximity of a particular patient connected device to a wireless patient connected device detector; and
a channel allocator for automatically allocating a particular communication channel of said plurality of communication channels for use in acquiring medical data from said particular patient on said particular communication channel using predetermined channel allocation rules in response to detection of proximity of said particular patient connected device to said detector.

12. A system according to claim 11 wherein said predetermined channel allocation rules allocate a channel to a patient connected device based on at least one of: (a) ascending channel number order, and (b) a first come first served rule.

13. A system according to claim 11 wherein:
said communication interface receives a message including data identifying a second patient connected device identifier of a second patient connected device attached to said particular patient; and
said user interface initiates generation of a message to a user prompting said user to enter data enabling allocation of a second particular communication channel to be used in acquiring medical data using said second patient connected device.

14. A medical data telemetry management system for managing acquisition of patient medical data derived from a plurality of patient connected devices, comprising:
an acquisition processor for acquiring medical data from a plurality of different patients attached to a plurality of patient connected devices using a corresponding plurality of communication channels;
a communication interface for receiving a message, including a particular patient connected device identifier, generated in response to detection of proximity of a particular patient connected device to a wireless patient connected device detector; and
an identifier allocator for automatically associating an identifier with medical data acquired from said particular patient in response to detection of proximity of said particular patient connected device to said detector.

15. A system according to claim 14 wherein said identifier allocator associates at least one of: (a) a patient identifier, (b) a patient locator identifier, (c) a patient room, and (d) a patient associated label, with said particular patient in response to detection of proximity of said particular patient connected device to said detector.

16. A system according to claim 14 further comprising a channel allocator for automatically allocating a particular communication channel of said plurality of communication channels for use in acquiring medical data from said particular patient on said particular communication channel using predetermined channel allocation rules in response to detection of proximity of said particular patient connected device to said detector.

17. A medical data telemetry management system for managing acquisition of patient medical data derived from a plurality of patient connected devices, comprising:
an acquisition processor for acquiring medical data from a plurality of different patients attached to a plurality of patient connected devices using a corresponding plurality of communication channels;
a communication interface for receiving a message including a particular patient connected device identifier and a patient identifier identifying a patient attached to said particular patient connected device identifier, said message being generated in response to detection of proximity of a particular patient connected device to a wireless patient connected device detector; and
a channel allocator for automatically allocating a particular communication channel of said plurality of communication channels for use in acquiring medical data from said particular patient on said particular communication channel using predetermined channel allocation rules and associating acquired medical data received on said particular communication channel with said patient identifier, in response to detection of proximity of said particular patient connected device to said detector.

18. A system according to claim 17 further comprising a display generator for initiating generation of data representing a display image including said acquired medical data received on said particular communication channel associated with at least one of: (a) said patient identifier, and (b) a name of said particular patient.

19. A system according to claim 17 wherein
said communication interface receives a message including data identifying a second patient connected device identifier of a second patient connected device attached to said particular patient; and
said channel allocator automatically allocates a second particular communication channel of said plurality of communication channels for use in acquiring medical data using said second patient connected device.

20. A method for managing acquisition of patient medical data derived from a plurality of patient connected devices, comprising the activities of:
acquiring medical data from a plurality of different patients attached to a plurality of patient connected devices using a corresponding plurality of communication channels;
receiving a message including a particular patient connected device identifier generated in response to detection of proximity of a particular patient connected device to a wireless patient connected device detector; and
in response to detection of proximity of said particular patient connected device to said detector, initiating generation of a message to a user prompting said user to enter data enabling allocation of a particular communication channel of said plurality of communication channels for use in acquiring medical data from said particular patient on said particular communication channel.

21. A method for managing acquisition of patient medical data derived from a plurality of patient connected devices, comprising the activities of:
acquiring medical data from a plurality of different patients attached to a plurality of patient connected devices using a corresponding plurality of communication channels;
receiving a message including a particular patient connected device identifier generated in response to detection of proximity of a particular patient connected device to a wireless patient connected device detector; and
automatically allocating a particular communication channel of said plurality of communication channels for use in acquiring medical data from said particular patient on said particular communication channel using predetermined channel allocation rules in response to detection of proximity of said particular patient connected device to said detector.
